(19) United States
(12) Patent Application Publication
(10) Pub. No.: US 2013/0144885 A1
(43) Pub. Date: Jun. 6, 2013

(54) FILE SEARCH APPARATUS AND METHOD USING ATTRIBUTE INFORMATION

(71) Applicant: Electronics and Telecommunications Research, Daejeon (KR)

(72) Inventors: Youn-Hee GIL, Daejeon (KR); Jooyoung LEE, Daejeon (KR); Su Hyung JO, Daejeon (KR); Sung Kyong UN, Daejeon (KR); Woo Yong CHOI, Daejeon (KR); Keonwoo KIM, Daejeon (KR); Sang Su LEE, Daejeon (KR); YOUNGSOO KIM, Daejeon (KR); Do Won HONG, Daejeon (KR)

(73) Assignee: Electronics and Telecommunications Research Institute, Daejeon (KR)

(21) Appl. No.: 13/705,076

(22) Filed: Dec. 4, 2012

(30) Foreign Application Priority Data
Dec. 5, 2011 (KR) 10-2011-0129062

(51) Int. Cl. G06F 17/30

(52) U.S. Cl. CPC G06F 17/30106
USPC 707/741

(57) ABSTRACT

A file search apparatus using attribute information, includes an attribute extraction unit configured to extract attribute information by analyzing a file; and a distributed index generation unit configured to generate an attribute-based index database on the basis of the attribute information of the file. Further, the file search apparatus includes a storage unit configured to store the attribute-based index database; and a file search unit configured to search, when a query is input, an index database corresponding to the query in the storage unit to generate a search result.

### CROSS-REFERENCE TO RELATED APPLICATION(S)

The present invention claims priority of Korean Patent Application No. 10-2011-0129062, filed on Dec. 5, 2011, which is incorporated herein by reference.

### FIELD OF THE INVENTION

The present invention relates to file search, and more particularly, to a file search apparatus and method using attribute information, which generate an index with file attributes, processes a user's query on a corresponding attribute, and provides the processed result in real time.

### BACKGROUND OF THE INVENTION

A conventional index system extracts a text file included in a file, extracts index words in a technique such as morpheme analysis, and generates an inverted file for the index words. In this case, when there is a user's query, the conventional index system tracks index words associated with corresponding keywords, and provides a file, linked to the index words, as the traced result.

A desktop index is technology that analyzes in advance data stored in a hard disk of a personal computer to generate an index database, and provides the analyzed result to a user in real time. Search provided by a window explorer full-searches a target region of a hard disk to provide the searched result each time there is a user's search request, and thus, as the size of search target data increases, a search time is extended. Therefore, as the capacity of a hard disk increases, desktop index technology increases in utility.

### SUMMARY OF THE INVENTION

In view of the above, the present invention provides a file search apparatus and method using attribute information, which analyze attribute information of a file to generate an attribute-based index database, and generate a search result corresponding to a user's query on the basis of the index database.

Further, the present invention provides a file search apparatus and method using attribute information, which separately sort and manage a suspicious file including potential digital evidence when analyzing attribute information of files, and thus enable the review of the suspicious file including the potential digital evidence.

In accordance with a first aspect of the present invention, there is provided a file search apparatus using attribute information, including: an attribute extraction unit configured to extract attribute information by analyzing a file; a distributed index generation unit configured to generate an attribute-based index database on the basis of the attribute information of the file; a storage unit configured to store the attribute-based index database; and a file search unit configured to search, when a query is input, an index database corresponding to the query in the storage unit to generate a search result.

The file search apparatus may further comprise a file sort unit configured to sort the file according to whether the file is a compressed file, and provide the file to the attribute extraction unit when the file is not the compressed file; and a decompression unit configured to decompress, when the file is a compressed file, the file and provide the decompressed file to the decompression unit.

Further, the file search apparatus may further comprise a distributed index management unit configured to perform an addition function, an update function, or a deletion function on the index database stored in the storage unit.

The attribute extraction unit may determine the file as a suspicious file when it is analyzed that the attribute of the file differs from signature information of the file, an extension of the file has been changed, or a capacity in the attribute of the file differs from an actual capacity of the file.

Further, the file search apparatus may further comprise a suspicious file processing unit configured to store the file determined as the suspicious file in a storage space, and provide the suspicious file stored in the storage space to the suspicious file processing unit according to a user's request.

Furthermore, the file search apparatus may further comprise a graphics output unit configured to process the search result into a graphics type, and output the processed search result.

The attribute information of the file may include one or more of a creator, a file format, a created date, and a file size.

In accordance with a second aspect of the present invention, there is provided a file search method using attribute information, including: analyzing one or more files stored in a storage device to extract attribute information of each of the files; generating an attribute-based index database on the basis of the attribute information of each file; and searching, when a query for file search is inputted, the attribute-based index database on the basis of the query to generate a search result based on the query.

Further, said extracting attribute information may include decompressing, when a file stored in the storage device is a compressed file, the compressed file; and extracting attribute information of the decompressed file.

The file search method may further comprise determining the file as a suspicious file when it is analyzed that the attribute of the file differs from signature information of the file, an extension of the file has been changed, or a capacity in the attribute of the file differs from an actual capacity of the file.

Further, the file search method may further comprise processing the search result into a graphics type, and outputting the processed search result.

In accordance with the embodiments of the present invention, the file search apparatus and method may generate the multi-index database for each attribute of files in a search target disk, and may provide files corresponding to a user's query in real time.

Furthermore, the present invention ma y separately sort and manage a suspicious file including potential digital evidence when analyzing attribute information of files, and thus may enable the review of the suspicious file including the potential digital evidence.

### BRIEF DESCRIPTION OF THE DRAWINGS

The objects and features of the present invention will become apparent from the following description of embodiments given in conjunction with the accompanying drawings, in which:

FIG. 1 is a block diagram illustrating a file search apparatus using attribute information in accordance with an embodiment of the present invention;

FIGS. 2A to 2C are exemplary diagrams illustrating attribute information of files used in an embodiment of the present invention;

FIG. 3 is a diagram illustrating a structure of a compound file;

FIG. 4 is a diagram illustrating a structure of a Hangul file;

FIG. 5 is a flow chart illustrating an operation of the file search apparatus using attribute information in accordance with an embodiment of the present invention; and

FIGS. 6 and 7 are exemplary diagrams of graphics screens showing search results outputted from the file search apparatus using attribute information in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

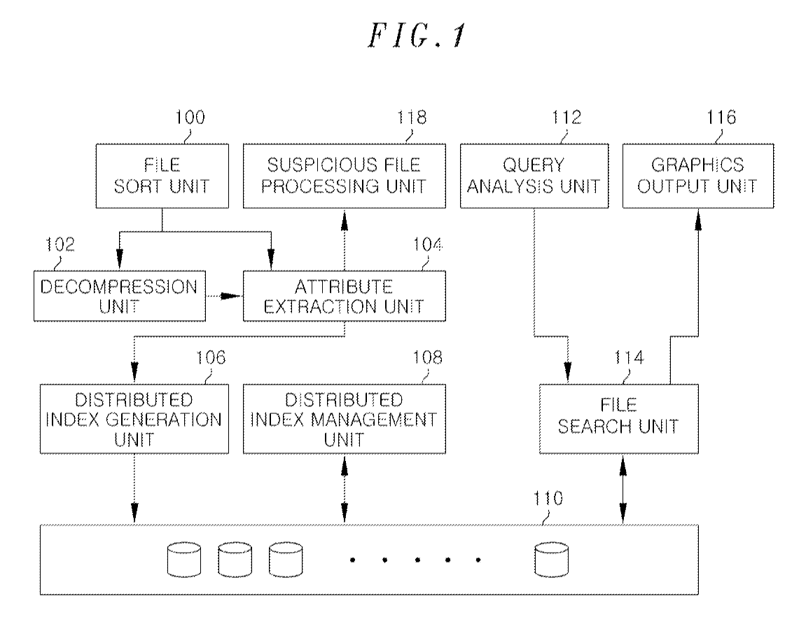

FIG. 1 is a block diagram illustrating a file search apparatus using attribute information in accordance with an embodiment of the present invention.

Referring to FIG. 1, the file search apparatus includes a file sort unit 100, a decompression unit 102, an attribute extraction unit 104, a distributed index generation unit 106, a distributed index management unit 108, a metadata index storage unit 110, a query analysis unit 112, a file search unit 114, a graphics output unit 116, and a suspicious file processing unit 118.

The file sort unit 100 may sort a file supplied from a storage device (not shown), e.g., a hard disk, an optical disk or the like, and provide the file to the decompression unit 102 or the attribute extraction unit 104. For example, when the file is a compressed file, the file sort unit 100 may provide the file to the decompression unit 102, and provide the other files to the attribute extraction unit 104.

When the file is a compressed file, the decompression unit 102 may decompress the file, and provide the decompressed file to the attribute extraction unit 104.

The attribute extraction unit 104 may analyze a header of the file, supplied from the file sort unit 100 or the decompression unit 102, to determine the kind of the file, and extract attributes supplied by kind. This will now be described.

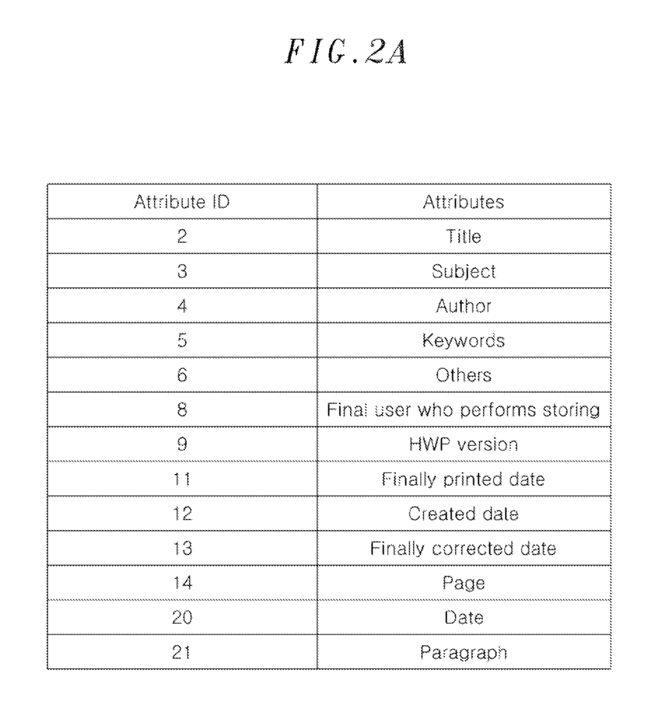

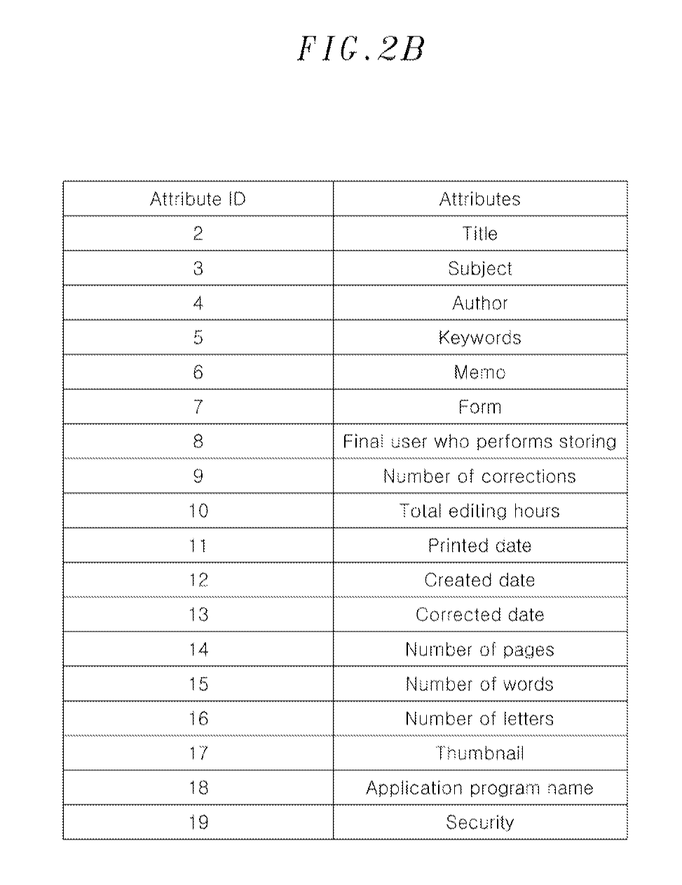

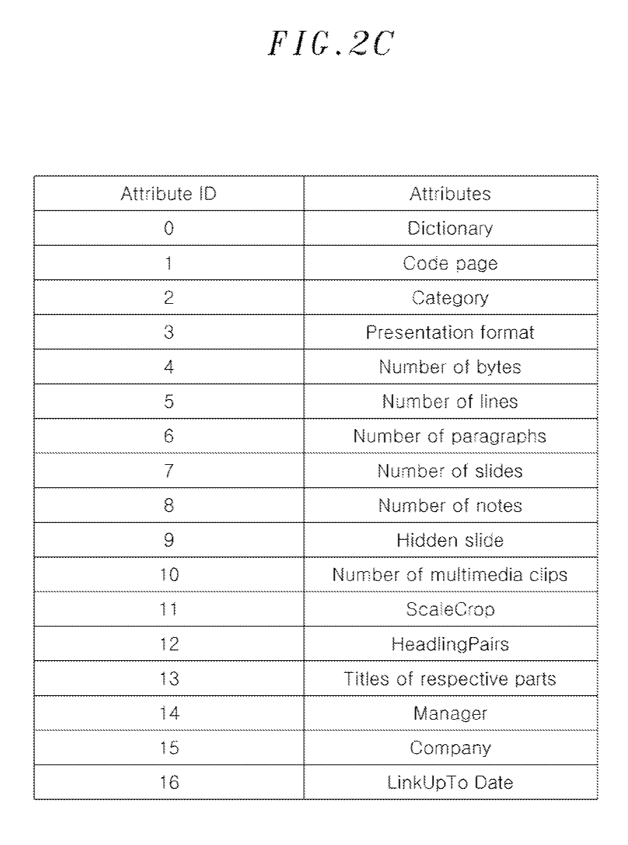

All files, which are stored in a digital format in a hard disk or an optical disk, include attribute information. For example, the attribute information may simply include a file format, a file size, and a generated date, and moreover may further include a corrected date, the first creator, the final storage user, keywords, the kind of an application program, summary information on contents included in a file, etc. For example, as illustrated in FIGS. 2A to 2C, attribute information provided from the Hangul and MS office group that is widely used includes a title, a subject, an author, keywords, the final storage user, version information, the finally printed date, a created date, the finally corrected date, the number of pages, the number of words, the number of letters, and the like. On the basis of such information, an index database for each corrected date, each creator, and each application program may be generated in advance, and a corresponding file may be provided in real time according to a user's query.

When a file is a document, the attribute extraction unit 104 determines the structure of the document and parses a heard structure including attribute information of the document to extract externally stored information, for extracting the attribute of the document. To this end, the attribute extraction unit 104 determines the structure of a document for each application program and analyzes header information.

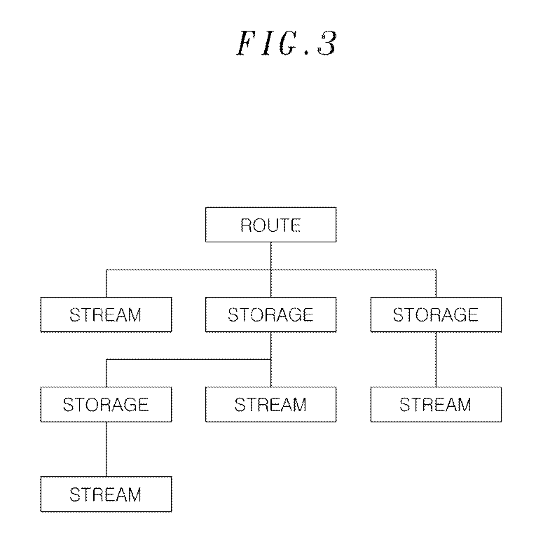

Haansoft Hangul 2002-2010 files and Microsoft Word/Excel/PowerPoint 97-2003 files have a compound document file format, and store internal data. The attribute extraction unit 104 may analyze the internal storage format of a compound document file, for extracting attribute information. The structure of a compound file is as shown in FIG. 3. That is, the structure of the compound document file is similar to a file system (e.g., FAT or the like) that is used in an operating system (OS). The compound document file is configured in a hierarchical structure of storages and streams, which are managed with metadata (attribute).

A compound document corresponds to the organized collection of user interfaces that configures one integrated perception environment, and has a structure including different data formats such as texts, audio, and video. The compound document provides an environment that enables files, created in various application programs, to be edited in one application program. For example, when PowerPoint document or MS Excel document is inserted into MS word document, by editing the MS word document, the inserted document may be edited without driving PowerPoint or MS Excel. Such characteristic is called object linking embedding (OLE), and a compound document is called an OLE compound document.

The storage types of document files such as Haansoft Hangul and MS Word/Excel/PowerPoint differ by application programs. Particularly, a specific application program fundamentally compresses and stores data. Therefore, it is required to thoroughly analyze the storage position and storage type of a meaningful text, for extracting a text from a corresponding file.

Similarly to Hangul 2002 file or higher files, Microsoft Word 97-2003 files use a compound document file format. A file internally has several streams, and Word Document stream stores a body text. The body text is stored in OEM ASCII and Unicode, and stored in units of a block having a certain size.

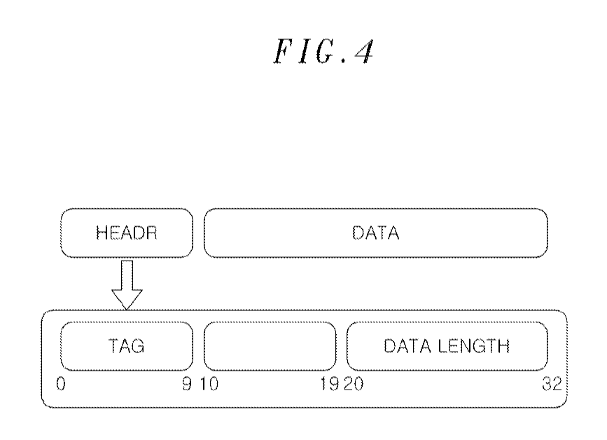

Therefore, when a file is a compound document, the attribute extraction unit 104 extracts a header by analyzing the compound document, and analyzes attribute information of the compound document from the header. For example, as shown in FIG. 4, a Hangul file includes a header and data, and the attribute extraction unit 104 extracts the header from the Hangul file, and analyzes the header to extract attribute information of the Hangul file.

Attributes of document files such as Hangul and MS office and attributes of general files such as video files, audio files, and compressed files are stored in a header. The attribute extraction unit 104 may analyze an input file to extract a header from the input file, and parse each record information of the header to extract attribute information from the header.

The distributed index generation unit 106 may generate an attribute-based index database with the attribute information extracted from the attribute extraction unit 104, and store the index database in the metadata index storage unit 110. That is, when four pieces of attribute information is extracted from an arbitrary file, the distributed index generation unit 106 may generate four index databases and store the four index databases in the index storage unit 110.

The distributed index management unit 108 may provide addition, update, and deletion functions on the index database stored in the metadata index storage unit 110.

When there is a user's query, the query analysis unit 112 may analyze the query, and provide the analyzed result to the file analysis unit 114. As an example of a user's query, there is the search of a file that has been created for a duration of “YYYY-MM-DD to YYYY-MM-DD”, the search of a file created by a user 1, the search of a file that has been created as a specific application program, and the search of a file having a specific size of MB or more.

The file search unit 114 may search an index database stored in the metadata index storage unit 110 on the basis of the analyzed query, and generate a search result corresponding to the index database.

The graphics output unit 116 may output the search result, generated by the file search unit 114, in a graphics type.

When a suspicious file or an unusual file is founded in extracting the attribute of a file, the attribute extraction unit 104 may provide the suspicious file or the unusual file to the suspicious file processing unit 118, in which case the suspicious file processing unit 118 separately manages the suspicious file or unusual file supplied from the attribute extraction unit 104 and provides information on a corresponding file to a user. For example, when an extension of a file name differs from signature information as an attribute search result, there is a high probability that a corresponding file is a file whose an extension has been changed by a user for deliberately hiding specific data. In this case, a corresponding file is a meaningful file forensically, and thus is separately provided to a user. Also, when a capacity in an attribute of a file differs from an actual capacity of the file, hidden data may be concealed in the file, and thus, the hidden data is provided to be used in a forensic analysis operation.

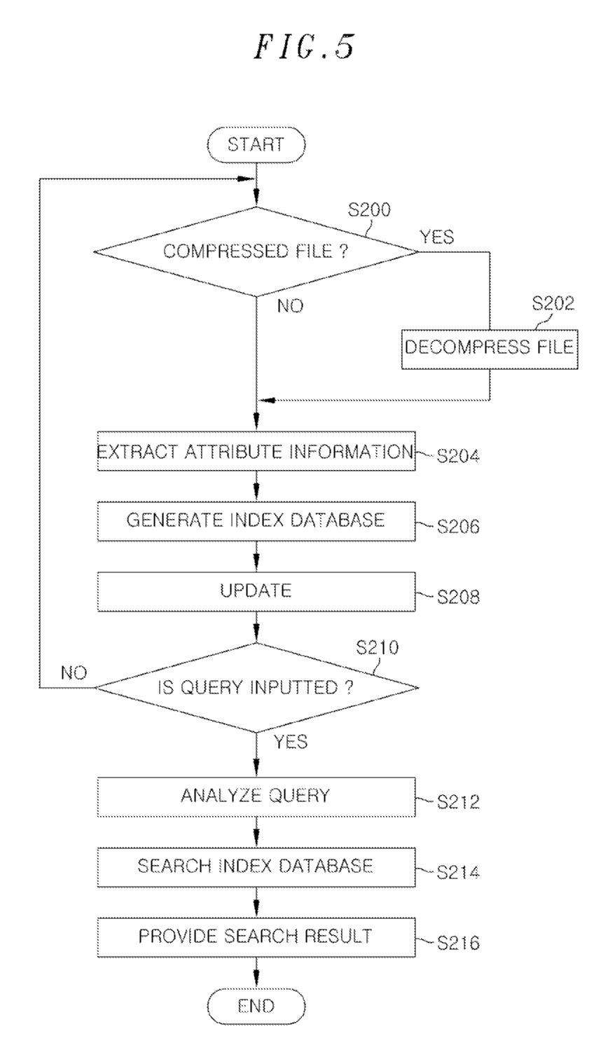

The file search apparatus using the above-described attribute information analyzes the attribute of a file to generate an index database. An operation of performing a search on the basis of the index database will now be described with reference to FIGS. 5 to 7.

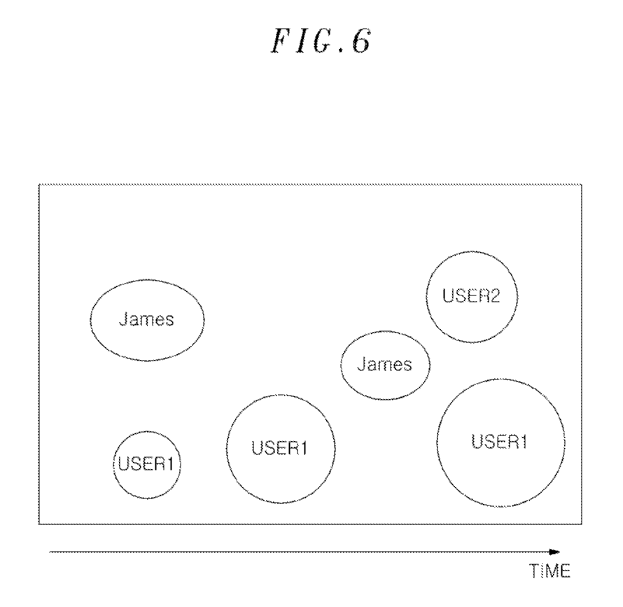

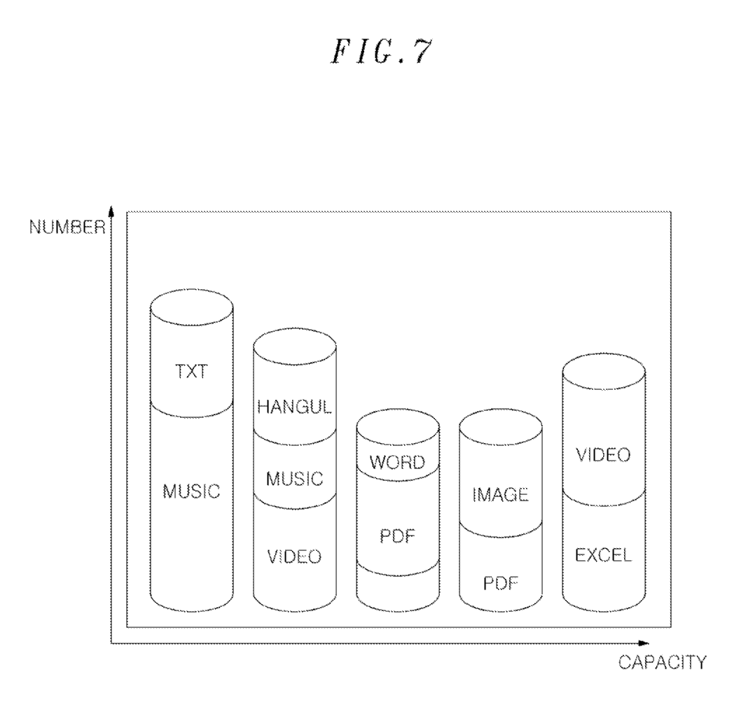

FIG. 5 is a flow chart illustrating an operation of the file search apparatus using attribute information in accordance with an embodiment of the present invention. FIGS. 6 and 7 are exemplary diagrams of graphics screens showing search results outputted from the file search apparatus using attribute information in accordance with an embodiment of the present invention.

As shown in FIG. 5, when a file is inputted from the outside, the file sort unit 100 may determine whether the file is a compressed file or a general file in step S200. When the input file is the compressed file, the file sort unit 100 may provide the input file to the decompression unit 102, but when the input file is not the compressed file, the file sort unit 100 may provide the input file to the attribute extraction unit 104. In step S202, the decompression unit 102 may receive the compressed file from the file sort unit 100 to decompress the received file, and then may provide the decompressed file to the attribute extraction unit 104.

In step S204, the attribute extraction unit 104 may analyze the decompressed file or the file supplied from the file sort unit 100 to extract attribute information of the file, and then may provide the extracted attribute information to the distributed index generation unit 106.

In step S206, the distributed index generation unit 106 may generate an attribute-based index database on the basis of the attribute information of the file, and then, in step S208, may update the metadata index storage unit 110 with the attribute-based index database. For example, when the metadata index storage unit 110 includes a database corresponding to the attribute-based index database, the metadata index storage unit 110 is updated by merging the attribute-based index database and the database included in the metadata index storage unit 110.

Through the above-described operation, the distributed index generation unit 106 generates an index database on the basis of attribute information on each file, and stores the index database in the metadata index storage unit 110.

While an index database is generated through the above-described operation, whether a query for file search is input from the outside is determined in step S210. If it is determined that the query for the file search is not input from the outside in step S210, the control step goes back to step S200. On the other hand, if it is determined that the query for file search is input from the outside in step S210, the query analysis unit 112 may analyze the input query in step S212, and may provide the analyzed result to the file search unit 114.

In step S214, the file search unit 114 may search index databases stored in the metadata index storage unit 110 on the basis of the analyzed query, and, in operation S216, may provide the searched result to a user through the graphics output unit 116.

For example, when a query for a specific application program is input, the file search unit 114 may search an index database having an attribute for the specific application program in the metadata index storage unit 110, and may generate a search result on the searched index database.

Moreover, when a query that indicates the search of all files by creator and time is input, the file search unit 114 may search index databases having attributes for creators and time in the metadata index storage unit 110, and may generate a search result on the basis of the searched index database. The graphics output unit 116 may display the search result in a type shown in FIG. 6.

Moreover, when a query that indicates the search of all files by capacity is input, the file search unit 114 may search index databases having attributes for capacities in the metadata index storage unit 110, and may generate a search result on the basis of the searched index database. The graphics output unit 116 may display the search result in a type shown in FIG. 7.

Although not described in the file search method in accordance with an embodiment of the present invention, a suspicious file or an unusual file may be founded in analyzing the attribute of a file. For example, when an extension of a file name differs from signature information as an attribute search result, there is a high probability that a corresponding file is a file whose an extension has been changed by a user for deliberately hiding specific data. In this case, a corresponding file is a meaningful file forensically, and thus is separately provided to a user. Further, when the capacity of a file differs from that of an actual file in an attribute, hidden data may be concealed in the file, and thus, the hidden data is provided to be used in a forensic analysis operation.

In accordance with the embodiments of the present invention, the file search apparatus and method may generate the multi-index database for each attribute of files in a search target disk, and may provide files corresponding to a user's query in real time.

Furthermore, the present invention may separately sort and manage a suspicious file including potential digital evidence when analyzing attribute information of files, and thus may enable the review of the suspicious file including the potential digital evidence.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A file search apparatus using attribute information, comprising:
an attribute extraction unit configured to extract attribute information by analyzing a file;
a distributed index generation unit configured to generate an attribute-based index database on the basis of the attribute information of the file;
a storage unit configured to store the attribute-based index database; and
a file search unit configured to search, when a query is input, an index database corresponding to the query in the storage unit to generate a search result.

2. The file search apparatus of claim 1, further comprising:
a file sort unit configured to sort the file according to whether the file is a compressed file, and provide the file to the attribute extraction unit when the file is not the compressed file; and
a decompression unit configured to decompress, when the file is a compressed file, the file and provide the decompressed file to the decompression unit.

3. The file search apparatus of claim 1, further comprising a distributed index management unit configured to perform an addition function, an update function, or a deletion function on the index database stored in the storage unit.

4. The file search apparatus of claim 1, wherein the attribute extraction unit determines the file as a suspicious file when it is analyzed that the attribute of the file differs from signature information of the file, an extension of the file has been changed, or a capacity in the attribute of the file differs from an actual capacity of the file.

5. The file search apparatus of claim 4, further comprising a suspicious file processing unit configured to store the file determined as the suspicious file in a storage space, and provide the suspicious file stored in the storage space to the suspicious file processing unit according to a user's request.

6. The file search apparatus of claim 1, further comprising a graphics output unit configured to process the search result into a graphics type, and output the processed search result.

7. The file search apparatus of claim 1, wherein the attribute information of the file includes one or more of a creator, a file format, a created date, and a file size.

8. A file search method using attribute information, including:
analyzing one or more files stored in a storage device to extract attribute information of each of the files;
generating an attribute-based index database on the basis of the attribute information of each file; and
searching, when a query for file search is inputted, the attribute-based index database on the basis of the query to generate a search result based on the query.

9. The file search method of claim 8, wherein said extracting attribute information includes:
decompressing, when a file stored in the storage device is a compressed file, the compressed file; and
extracting attribute information of the decompressed file.

10. The file search method of claim 8, further comprising determining the file as a suspicious file when it is analyzed that the attribute of the file differs from signature information of the file, an extension of the file has been changed, or a capacity in the attribute of the file differs from an actual capacity of the file.

11. The file search method of claim 8, further comprising processing the search result into a graphics type, and outputting the processed search result.
